(19) United States
(12) Patent Application Publication
(10) Pub. No.: US 2003/0043751 A1
(43) Pub. Date: Mar. 6, 2003

(54) Apparatus and method for resetting remote ATM-based equipment

(76) Inventor: Paul G. Nelson, Frisco, TX (US)

Correspondence Address: Docket Clerk, P.O. Drawer 800889, Dallas, TX, 75380, US

(21) Appl. No.: 09/947,489

(22) Filed: Sep. 6, 2001

(51) Int. Cl. H04L 12/26; H04L 12/56

(52) U.S. Cl. 370/244; 370/395.1

(57) ABSTRACT

There is disclosed an apparatus for resetting an asynchronous transfer mode (ATM) compatible system. The apparatus comprises a reset detection circuit coupled to an input port of the ATM compatible system that receives from the input port an incoming ATM bitstream. The reset detection circuit compares data in the incoming ATM bitstream to a first reset bit pattern and generates a first reset signal in response to a match between the data in the incoming ATM bitstream and the first reset bit pattern.

### TECHNICAL FIELD OF THE INVENTION

The present invention is directed, in general, to asynchronous transfer mode (ATM) networks and, more specifically, to an apparatus and method for resetting a remote malfunctioning ATM-based device.

### BACKGROUND OF THE INVENTION

The popularity of local area networks (LANs) has led to the interconnection of remote LANs, computers, telephone equipment, manufacturing and refining equipment, and other systems into wide area networks (WANs) in order to make more resources available to users and to control the operations of many dispersed devices from a central location. The wide deployment of LANs and WANs has also led to an increase in the number of applications requiring very high-speed data transmission. Applications such as video conferencing need a large amount of bandwidth to transfer data and are relatively intolerant of switching delays.

Asynchronous transfer mode (ATM) switches are often used in communication networks that interconnect devices across large distances. ATM was originally intended as a service for the broadband public telephone network. Although designed primarily for the high-speed transfer of video and multimedia information, ATM has also proved popular in data transmission applications. ATM is widely used as the backbone of large business networks and in wide area networks.

ATM provides speeds from 50 Mbps up to 10 Gbps using fast packet switching technology for high performance. ATM uses small fixed-size packets called cells. An exemplary cell may comprise a 53-byte packet that has 5 bytes of header/descriptor information and a 48-byte payload of voice, data or video traffic. The header information contains routing tags and/or multi-cast group numbers that are used to configure switches in the ATM network path to deliver the cells to the final destination.

In ordinary operation, failures inevitably occur in the switches in a communication network and in the end-user devices connected to the switches. It is preferable to automatically reset a malfunctioning device from a central location in a communication network because it is faster and less costly than dispatching maintenance personnel. One conventional method for resetting an ATM apparatus (switch or end-user device) sends an ATM reset message that is processed by the ATM processing circuitry (i.e., cell delineation block and segmentation and reassembly block) and the message handler of the ATM apparatus. Unfortunately, this has the disadvantage that the ATM processing circuitry and message handler must be functioning properly. Typically, these are complex circuits that rely on software for proper operation. It is unlikely that a remote reset message would be needed if the message handler and ATM processing circuitry were operating properly in the first place. Another conventional method for resetting an ATM apparatus uses a dedicated line to the remote equipment for maintenance commands. This increases the cost and complexity of the remote equipment and adds the cost of the additional communication lines that must be connected to all such devices.

Therefore, there is a need in the art for improved systems and methods for resetting remote ATM switches and end-user devices. More particularly, there is a need in the art for improved systems and methods for resetting remote ATM switches and end-user devices that do not rely on the ATM cell processing circuitry of the remote malfunctioning device and that do not require separate dedicated reset control lines and circuitry.

### SUMMARY OF THE INVENTION

To address the above-discussed deficiencies of the prior art, it is a primary object of the present invention to provide an apparatus and related method for enabling a central location to reset remote ATM (Asynchronous Transfer Mode) based equipment, even when the remote equipment is malfunctioning. A reset apparatus according to the principles of the present invention is used as a last resort when the remote equipment does not respond to other commands. The present invention provides a reset method that uses minimum hardware and does not rely on the correct operation of software and large amounts of hardware in the remote equipment.

Accordingly, it is a primary object of the present invention to provide an apparatus for resetting an asynchronous transfer mode (ATM) compatible system. According to an advantageous embodiment of the present invention, the apparatus comprises a reset detection circuit coupled to an input port of the ATM compatible system that receives from the input port an incoming ATM bitstream. The reset detection circuit compares data in the incoming ATM bitstream to a first reset bit pattern and generates a first reset signal in response to a match between the data in the incoming ATM bitstream and the first reset bit pattern.

According to one embodiment of the present invention, the reset detection circuit compares data in the incoming ATM bitstream to a plurality of reset bit patterns and generates a selected reset signal in response to a match between the data in the incoming ATM bitstream and a corresponding one of the plurality of reset bit patterns.

According to another embodiment of the present invention, the reset detection circuit compares data within a payload portion of a first ATM cell in the incoming ATM bitstream to the first reset bit pattern.

According to still another embodiment of the present invention, the reset detection circuit compares data within payload portions of a plurality of ATM cells in the incoming ATM bitstream to the first reset bit pattern.

According to yet another embodiment of the present invention, the plurality of ATM cells are sequential.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation. Such a device may be implemented in hardware, firmware or software, or some combination of at least two of the same. In particular, a controller may comprise a data processor that executes program code stored in a memory, such as a random access memory (RAM), coupled to the data processor. Additionally, such a data processor and memory may be incorporated in an application specific integrated circuit (ASIC) chip. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary asynchronous transfer mode (ATM) network containing redundant ATM switches in accordance with the principles of the present invention;

FIG. 2 illustrates in greater detail an exemplary end-user device which comprises a remote reset apparatus according to the principles of the present invention; and

FIG. 3 is a flow diagram illustrating the operation of the exemplary remote reset apparatus according to one embodiment of the present invention.

### DETAILED DESCRIPTION OF THE INVENTION

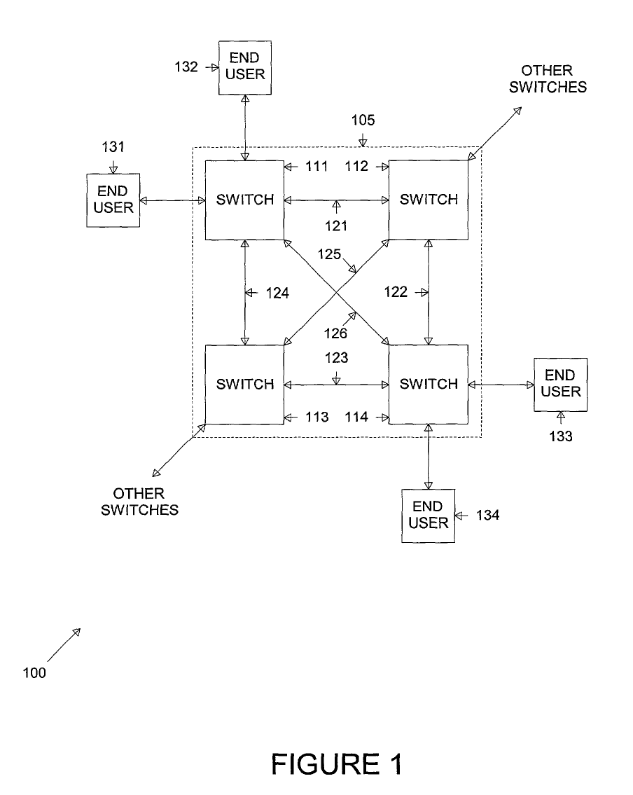

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged asynchronous transfer mode (ATM) network.

FIG. 1 illustrates exemplary asynchronous transfer mode (ATM) network 100 containing redundant ATM packet switches 111-114 in accordance with the principles of the present invention. ATM switching network 100 contains subnetwork 105 (indicated by a dotted line), which comprises ATM switches 111-114. ATM switches 111-114 interconnect end-user devices 131-134 with each other and with other switches (not shown) and other end-user devices (not shown) associated with ATM network 100. ATM switches 111-114 are interconnected by data links 121-126. Subnetwork 105 is intended to be a representative portion of ATM network 100, which may contain many other redundant ATM switches similar to ATM switches 111-114.

Each one of end-user devices 131-134 may comprise any commonly known processing device or remotely controllable system that may communicate via an ATM switching network. This may include a telephone, a personal computer (PC), a fax machine, an office LAN, a network server, a remote vending machine, manufacturing or refining equipment, remote communications equipment, or the like. For example, end-user device 131 may comprise a remote network server that is sending a data file to end-user device 133, which is a desktop PC. The data file that is to be transmitted is segmented into data packets in end-user device 131. An identifier for the data transfer is appended to each ATM cell. A sequence number is also appended to each ATM cell, as is a destination address associated with end-user device 133.

Next, the ATM cells are transferred to ATM switch 111. ATM switch 111 may transfer the cells to end-user device 133 by several physical paths. For example, ATM switch 111 may send the ATM cells directly to ATM switch 114 across data link 126. If the data traffic load on data link 126 is heavy, ATM switch 111 may send some or all of the cells indirectly to ATM switch 114 via data link 121, ATM switch 112, and data link 122. Alternatively, ATM switch 111 may send some or all of the ATM cells indirectly to ATM switch 114 via data link 124, ATM switch 113, and data link 123. ATM switch 114 transfers the ATM cells to end-user device 133, which uses the identifier information and the sequence numbers from each ATM cell to reassemble the original data file sent by end-user device 131.

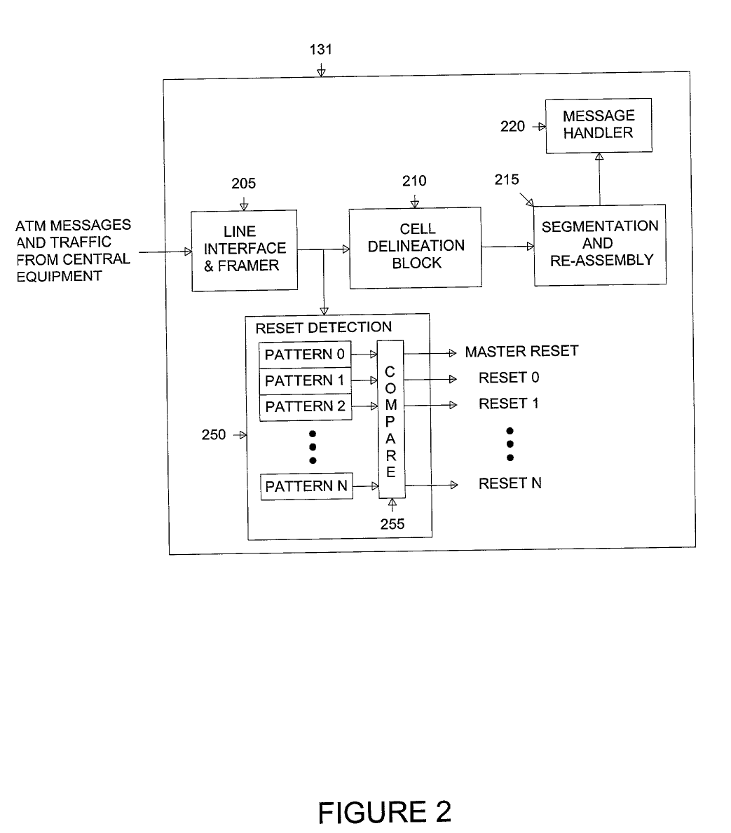

FIG. 2 illustrates in greater detail exemplary end-user device 131, which comprises a remote reset apparatus according to the principles of the present invention. Those skilled in the art will recognize that this is by way of example only and that a remote reset apparatus according to the principles of the present invention may also be incorporated into one or more of ATM switches 111-114. End-user device 131 comprises line interface & framer unit 205, cell delineation block 210, segmentation and re-assembly unit 215, and message handler circuitry 220. During ordinary operations, line interface and framer unit 205 receives incoming ATM cells from the network and produces a bit stream of header and payload data that are transferred to cell delineation block 210. Cell delineation block 210 identifies the boundaries of the cells. For example, assuming the message protocol is AAL5, each ATM cell contains 53 octets, including a 40 octet payload. Segmentation and re-assembly unit 215 reassembles the payloads into larger related data blocks and transfers the data blocks to message handler circuitry 220, which may be, for example, a data processor or a controller.

End-user device 131 further comprises reset detection circuitry 250, which detects one or more types of ATM reset messages transmitted to end-user device 131. Reset detection circuitry 250 does not rely on the ATM cell processing circuitry described above. Reset detection circuitry 250 also does not rely on message handler circuitry 220 or any software. Instead, reset detection circuitry 250 comprises dedicated hardware that detects the reset message and resets the remote equipment. Only a small portion of the ATM cell processing circuitry (i.e., line interface and framer unit 205) in remote equipment (i.e., end-user device 131) must be functioning in order to detect one or more reset messages. Since reset detection circuitry 250 is connected to the existing ATM path, no dedicated maintenance line is required.

ATM header detection is complex, so a great deal of circuitry would be required to implement cell delineation in the traditional way (i.e., using the Header Error Correction field). However, there is no need to use the HEC field to determine cell alignment. In order to simplify remote resetting operations, reset detection circuitry 250 searches for the pre-defined payload of the reset message. The reset message is structured in such a way that cell alignment can be determined solely from the payload portions of the message. The rest of the message must be simple enough to be easily detected but adequately complex to prevent false triggering of the reset.

There are several message structures that meet these requirements and can be implemented in a commercially available FPGA or PLD. For example, assuming 53-octet ATM cells having 40-octet payloads are used, the payload could consist of the sequential numbers 0, 1, 2, 3, 4, . . . , 38, 39 in 8-bit format. A detector for this type of pattern is easily implemented even if cell delineation is not known in advance. This pattern would be repeated for a time long enough to insure that it is not voice or data traffic (4000 repetitions, for example). Once a sufficient number of consecutive reset messages have been detected, reset detection circuitry 250 may reset end-user device 131. If greater complexity is desired, the initial sequence of messages may be followed by a different message, again repeated to insure that it is not voice or data traffic. Many combinations are possible. Also, once reset detection circuitry 250 determines cell alignment from the message payload, reset detection circuitry 250 may check fields in the ATM cell header or trailer.

There are many alternative message sequences that can be used as the reset sequence. The description above describes only one. Any reset message sequence must be complex enough to avoid false triggering, must allow for cell delineation based on the message payload, and must be simple enough to allow for easy detection. Also, similar sequences can be used for other ATM protocols with minor changes. For example, if AAL0 is used, a 48-octet payload can be used instead of the 40-octet payload described in the example above.

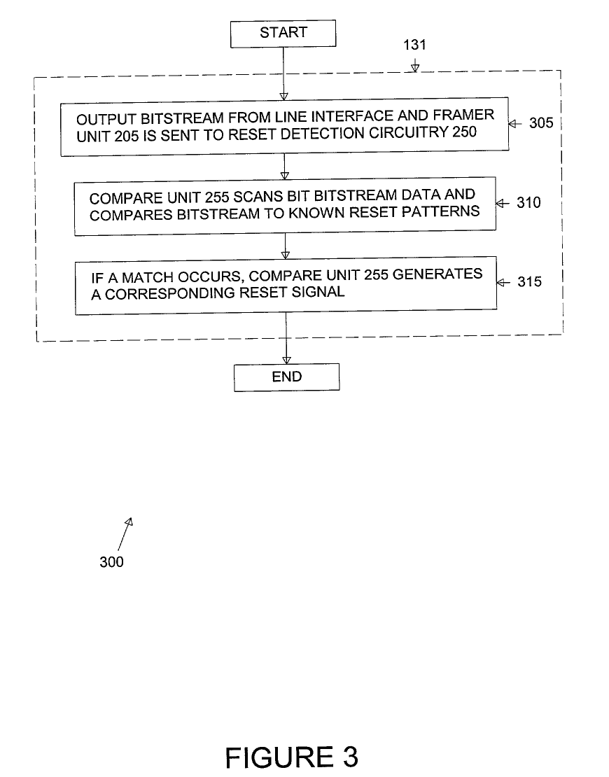

According to an exemplary embodiment of the present invention, reset detection circuitry 250 comprises compare unit 255, which compares the payloads of the bit stream at the output of line interface and framer unit 205 with one or more reset bit patterns stored in reset detection circuitry 250. Exemplary reset bit patterns arbitrarily labeled Pattern 0, Pattern 1, Pattern 2, and Pattern N are shown. FIG. 3 depicts flow diagram 300, which illustrates the operation of exemplary reset detection circuitry 250 according to one embodiment of the present invention. During normal operation, the output bitstream from line interface and framer unit 205 is sent to reset detection circuitry 250. Within reset detection circuitry 250, compare unit 255 continually scans the received bitstream data and compares the bitstream to one or more known reset patterns. If a match occurs, compare unit 255 generates a corresponding reset signal, such as MASTER RESET, RESET 0, RESET 1, . . . , RESET N. The MASTER RESET signal may be used to restart (or reset) all of end-user device 131. The other reset signals may be used to selectively reset only certain portions of end-user device 131. This give maintenance personnel greater flexibility in diagnosing and repairing problems in end 5 user device 131.

The present invention proposes the use of the message payload to determine cell alignment. The previous method of determining cell alignment (using the HEC) requires significantly more circuitry and reduces the probability that the reset message will be detected in a fault condition. The proposed invention relies on minimum hardware to detect the reset command. The present invention provides an inexpensive and reliable method to implement a feature that is very useful for remote equipment, such as cellular base stations.

Although the present invention has been described in detail, those skilled in the art should understand that they can make various changes, substitutions and alterations herein without departing from the spirit and scope of the invention in its broadest form.

What is claimed is:

1. An apparatus for resetting an asynchronous transfer mode (ATM) compatible system, said apparatus comprising a reset detection circuit coupled to an input port of said ATM compatible system and capable of receiving from said input port an incoming ATM bitstream, wherein said reset detection circuit compares data in said incoming ATM bitstream to a first reset bit pattern and generates a first reset signal in response to a match between said data in said incoming ATM bitstream and said first reset bit pattern.

2. The apparatus as set forth in claim 1 wherein said reset detection circuit compares data in said incoming ATM bitstream to a plurality of reset bit patterns and generates a selected reset signal in response to a match between said data in said incoming ATM bitstream and a corresponding one of said plurality of reset bit patterns.

3. The apparatus as set forth in claim 1 wherein said reset detection circuit compares data within a payload portion of a first ATM cell in said incoming ATM bitstream to said first reset bit pattern.

4. The apparatus as set forth in claim 3 wherein said reset detection circuit compares data within payload portions of a plurality of ATM cells in said incoming ATM bitstream to said first reset bit pattern.

5. The apparatus as set forth in claim 3 wherein said plurality of ATM cells are sequential.

6. A communication network comprising:
a plurality of interconnected ATM switches;
a plurality of end-user devices coupled to said ATM switches and capable of communicating via said ATM switches; and
an apparatus for resetting at least one of said ATM switches and said end-user devices, said apparatus comprising a reset detection circuit coupled to an input port of said ATM compatible system and capable of receiving from said input port an incoming ATM bitstream, wherein said reset detection circuit compares data in said incoming ATM bitstream to a first reset bit pattern and generates a first reset signal in response to a match between said data in said incoming ATM bitstream and said first reset bit pattern.

7. The communication network as set forth in claim 6 wherein said reset detection circuit compares data in said incoming ATM bitstream to a plurality of reset bit patterns and generates a selected reset signal in response to a match between said data in said incoming ATM bitstream and a corresponding one of said plurality of reset bit patterns.

8. The communication network as set forth in claim 6 wherein said reset detection circuit compares data within a payload portion of a first ATM cell in said incoming ATM bitstream to said first reset bit pattern.

9. The communication network as set forth in claim 8 wherein said reset detection circuit compares data within payload portions of a plurality of ATM cells in said incoming ATM bitstream to said first reset bit pattern.

10. The communication network as set forth in claim 6 wherein said plurality of ATM cells are sequential.

11. A method for resetting an asynchronous transfer mode (ATM) compatible system comprising the steps of:
receiving from an input port of the ATM compatible system an incoming ATM bitstream;
comparing data in the incoming ATM bitstream to a first reset bit pattern; and
generating a first reset signal in response to a match between the data in the incoming ATM bitstream and the first reset bit pattern.

12. The method as set forth in claim 11 further comprising the steps of:
comparing data in the incoming ATM bitstream to a plurality of reset bit patterns; and
generating a selected reset signal in response to a match between the data in the incoming ATM bitstream and a corresponding one of the plurality of reset bit patterns.

13. The method as set forth in claim 11 wherein the step of comparing data in the incoming ATM bitstream comprises the substep of comparing data within a payload portion of a first ATM cell in the incoming ATM bitstream to the first reset bit pattern.

14. The method as set forth in claim 11 further comprising the substeps of:
comparing data within payload portions of a plurality of ATM cells in the incoming ATM bitstream to a plurality of reset bit patterns; and
generating a selected reset signal in response to a match between the data in the incoming ATM bitstream and a corresponding one of the plurality of reset bit patterns.

15. The method as set forth in claim 14 wherein the plurality of ATM cells are sequential.
